(19) United States
(12) Patent Application Publication
(10) Pub. No.: US 2003/0027067 A1
(43) Pub. Date: Feb. 6, 2003

(54) Magnetic one-component toner

(76) Inventors: Toru Takatsuna, Osaka-Shi (JP); Takashi Nagai, Osaka-Shi (JP); Hiroko Higuchi, Osaka-Shi (JP); Seiji Kikushima, Osaka-Shi (JP)

Correspondence Address: SMITH, GAMBRELL & RUSSELL, LLP, 1850 M STREET, N.W., SUITE 800, WASHINGTON, DC, 20036, US

(21) Appl. No.: 10/059,131

(22) Filed: Jan. 31, 2002

(30) Foreign Application Priority Data
Mar. 27, 2001 (JP) 2001-88967

(51) Int. Cl. G03G 9/097

(52) U.S. Cl. 430/108.1; 430/108.22; 430/108.4; 430/108.5

(57) ABSTRACT

In a magnetic one-component toner containing at least a binder resin, a charge control resin, and a magnetic powder, the charge control resin has a weight-average molecular weight of 1.5×10⁴ or less, contains 8 to 15% by weight of functional groups, and is added in 5 to 20 parts by weight to 100 parts by weight of the binder resin. This makes the toner highly safe for humans and the environment and excellent in fixability and electric chargeability.

### BACKGROUND OF THE INVENTION

1. Field of the Invention

The present invention relates to a toner for electrophotography as used to develop an electrostatic latent image formed by a method based on electrophotography, electrostatic recording, or the like. The present invention relates more particularly to a magnetic one-component toner.

2. Description of the Prior Art

Many methods of electrophotography are conventionally known. In general, such a method involves using a photoconductive substance, forming an electric latent image on a photoconductor by various means, then developing the electric latent image with a toner to form a visible toner image, then transferring the toner image onto a transfer material such as paper as required, and then fixing the image by application of heat, pressure, or the like to obtain a copy of the original image.

Also known are various methods of developing an electrostatic latent image with a toner to obtain a visible image, examples including magnetic brush development, cascade development, powder cloud development, fur brush development, and liquid development. Among these development methods, particularly widely practiced are the magnetic brush method, cascade method, fur brush method, and other method using a two-component developer that contains a toner and a carrier as its main ingredients. These methods are all excellent in that they produce satisfactory images relatively stably. However, they share common disadvantages associated with the two-component developer, specifically the deterioration of the carrier and the variation of the mixing ratio of the toner and carrier.

Thus, various development methods using a one-component developer that contains a toner alone have been proposed. Among these are many excellent methods using a magnetic one-component toner, i.e. a toner composed of magnetic toner particles.

A magnetic one-component toner offers a black color originating from the magnetic powder it contains, even without carbon black added to it. However, since it does not contain a carrier, how to charge it electrically constitutes a tricky problem. Customarily, a magnetic one-component toner is mixed chiefly with a charge control agent to be made able to be charged electrically.

As the aforementioned charge control agent, a metal complex or nigrosine dye is used. Many of such substances, however, contain a heavy metal or aniline, and therefore their use may be restricted if the guidelines for their safety are revised to be stricter in the future. The same may happen also with carbon black used as a colorant. In addition, adding a dye or the like as a charge control agent to a toner may have an adverse effect on the fixability of the toner.

### SUMMARY OF THE INVENTION

An object of the present invention is to provide a magnetic one-component toner that is safe to use and that offers excellent fixability and electrical chargeability. Another object of the present invention is to provide a magnetic one-component toner that produces satisfactory images over a prolonged period.

To achieve the above objects, according to the present invention, a magnetic one-component toner contains at least a binder resin, a charge control resin, and a magnetic powder. Here, the charge control resin has a weight-average molecular weight of 1.5×10⁴ or less, contains 8 to 15% by weight of functional groups, and is added in 5 to 20 parts by weight to 100 parts by weight of the binder resin. In the present specification, the functional group content in the charge control resin is expressed as a percentage by weight (wt %) of the total weight of monomer containing functional groups and of the corresponding counter ions relative to the total weight of the charge control resin.

### DESCRIPTION OF THE PREFERRED EMBODIMENTS

As a result of an intensive study made to examine whether it is possible or not to enhance the fixability and electrical chargeability of a magnetic one-component toner by using a charge control resin containing a functional group capable of controlling electric charge instead of a heavy metal or dye acting as a charge control agent mainly from the viewpoint of safety, the inventors of the present invention have found out that this is achieved by controlling the weight-average molecular weight of the charge control resin and the functional group content therein within particular ranges.

In a magnetic one-component toner according to the present invention, it is important that the weight-average molecular weight of the charge control resin contained therein be 1.5×10⁴ or less. If the weight-average molecular weight of the charge control resin is more than 1.5×10⁴, the toner exhibits poor fixability. On the other hand, there is no particular lower limit to the weight-average molecular weight of the charge control resin, however, from the viewpoint of the preservation stability of the toner, it is preferable that the weight-average molecular weight be 0.8×10⁴ or more.

It is also important that the functional group content in the charge control resin be 8 to 15% by weight. With a functional group content below 8% by weight, the toner cannot be charged with a sufficient amount of electric charge. This makes the electrical driving force resulting from the potential difference between the photoconductor and the development roller, i.e. the force by which the toner is driven, too weak relative to the magnetic force acting between the toner and the development sleeve. This makes it difficult for the toner to move from the development roller to the photoconductor, and thus results in low image density (ID). By contrast, with a functional group content above 15% by weight, the charge control resin exhibits poor dispersibility. This causes the toner to be charged unevenly, leaving some of the toner charged insufficiently or oppositely, and thus leads to low ID and increased fog density (FD).

It is also important that the charge control resin is added in 5 to 20 parts by weight to 100 parts by weight of the binder resin. With more than 20 parts by weight of the charge control resin added, as image formation is performed repeatedly, the toner becomes charged with increasing amounts of electric charge, and the ID becomes lower and lower. On the other hand, with less than 5 parts by weight of the charge control resin added, the toner is charged with an insufficient amount of electric charge. Thus, even if the desired ID is obtained in initial images, since a large proportion of the toner is charged with an insufficient amount of electric charge, as image formation is performed repeatedly, the electric driving force acting toward the photoconductor becomes weaker and weaker relative to the magnetic force acting toward the development sleeve, resulting in increasingly low ID.

Moreover, the toner charged with an insufficient amount of electric charge does not move to the photoconductor, but remains in the developer unit. When the developer unit is replenished with new toner, the new toner is easily charged electrically, and thus the old toner, i.e. the toner that has been remaining in the developer unit without being charged, tends to be charged oppositely. As a result, as image formation is performed repeatedly, the FD becomes increasingly high.

Binder Resin Components

Examples of the binder resin used in the present invention include: styrene-based resins (monopolymers and copolymers containing styrene or a substitution product of styrene), such as polystyrene, chloropolystyrene, poly-α-methylstyrene, styrene-chlorostyrene copolymer, styrene-propylene copolymer, styrene-butadiene copolymer, styrene-vinyl chloride copolymer, styrene-vinyl acetate copolymer, styrene-maleic acid copolymer, styrene-acrylic compound copolymer (such as styrene-acrylic acid copolymer, styrene-methyl acrylate copolymer, styrene-ethyl acrylate copolymer, styrene-butyl acrylate copolymer, styrene-octyl acrylate copolymer, and styrene-phenyl acrylate copolymer), styrene-methacrylic compound copolymer (such as styrene-methacrylic acid copolymer, styrene-methyl methacrylate copolymer, styrene-ethyl methacrylate copolymer, styrene-butyl methacrylate copolymer, styrene-octyl methacrylate copolymer, and styrene-phenyl methacrylate copolymer), styrene-α-methyl chloroacrylate copolymer, and styrene-acrylonitrile-acrylic ester copolymer; and other resins, such as polyvinyl chloride, low-molecular-weight polyethylene, low-molecular-weight polypropylene, ethylene-ethyl acrylate copolymer, polyvinyl butyral, ethylene-vinyl acetate copolymer, rosin-denatured maleic resin, phenol resin, epoxy resin, polyester resin, ionomer resin, polyurethane resin, silicone resin, ketone resin, xylene resin, and polyamide resin. These are used singly or as a mixture of two or more of them.

Charge Control Resin

An example of the charge control resin used in the present invention is a monomer that is used to produce the aforementioned binder resin and that has a functional group capable of controlling electric charge introduced therein. Functional groups are grouped into those positively charged and those negatively charged. Examples of positively charged functional groups include: basic nitrogen atoms, such as quaternary ammonium salts, and imidazole. Examples of negatively charged functional groups include: carboxyl group, sulfonic group, and hydroxyl group.

Examples of monomers containing a negatively charged functional group include: monomers containing an acidic group, such as (meth)acrylic acid, styrenesulfonic acid, and 2-acrylamide-2-methypropane; and monomers containing a perfluoro alkyl group, such as perfluoro hexylethyl (meth)acrylate, and perfluoro octylethyl (meth)acrylate, perfluoro decylethyl (meth)acrylate. Examples of monomers containing a positively charged functional group include: monomers containing an electron-releasing group: such as allylamine and quaternary vinyl pyridinium.

The monomer that is used, together with the aforementioned monomer containing a functional group, to produce the charge control resin may be any monomer that is used to produce the binder resin, examples of which including: vinyl-based monomers, acrylic-based monomers, vinyl ester-based monomers, vinyl ether-based monomers, diolefin-based monomers, and monoolefin-based monomers. These are used singly or as a mixture of two or more of them.

The charge control resin used in the present invention may be produced by any conventionally known process, such as radical polymerization, anionic polymerization, and living radical polymerization. Among these, from the viewpoint of reducing the production of homopolymers, i.e. improving the block ratio, anion polymerization and living radical polymerization are particularly recommendable.

Magnetic Powder

The magnetic powder used in the present invention may be of any conventionally known type, examples of which including: powder of a metal, such as iron, manganese, nickel, or cobalt; magnetite; and various types of ferrite, such as copper-zinc ferrites, barium-zinc ferrites, manganese-zinc ferrites, lithium-zinc ferrites, magnesium-manganese ferrites, magnesium-copper-zinc ferrites, and barium-nickel-zinc ferrites. Preferably, the particles of the magnetic powder have a diameter of 0.15 to 0.25 μm, and have a shape with edges. For example, preferably 50 to 100 parts by weight, and further preferably 60 to 90 parts by weight, of the magnetic powder is blended with 100 parts by weight of toner particles.

As required, a magnetic one-component toner according to the present invention may contain a mold release agent, an offsetting preventing agent, a plasticizer, a flowability enhancer, a colorant, and the like.

Mold Release Agent

The mold release agent, such as a wax, used in the present invention may be of any conventionally known type, examples of which including: aliphatic hydrocarbon waxes, such as paraffin wax, petroleum wax, polyethylene wax, polypropylene wax, oxidized polyethylene wax; and other types of wax, such as montan wax, Fischer-Tropsch wax, and carnauba wax.

A magnetic one-component toner according to the present invention may be produced by any conventionally known process. For example, the ingredients of the magnetic one-component toner are first dry-blended, and are then melt-kneaded in a kneader, mixer, or the like. The resulting substance is then coarse-crushed on a mill or the like, is then fine-crushed on a jet mill or the like, and is then dry-classified to obtain the magnetic one-component toner.

### EXAMPLES

The present invention will be further described below in terms of practical and comparative examples. It is to be understood, however, that the present invention is not limited in any way by these examples.

### Practical Examples 1 to 7 and Comparative Examples 1 to 7

The ingredients shown below were mixed in a Henschel mixer, were then kneaded in a twin-screw extruder, and were then cooled. The resulting substance was coarse-crushed on a phasor mill, was then fine-crushed on a turbo mill, and was then classified with a pneumatic classifier to prepare toner particles of Practical Examples 1 to 7 and Comparative Examples 1 to 7. Then, 0.6 parts by weight of silica that tends to be positively charged and 1.4 part by weight of titanium oxide were added to 100 parts by weight of toner particles of each type, and the mixture was dry-mixed to prepare the different types of magnetic one-component toner all having an average particle diameter of 7.2 μm.

| | |
|---|---|
| Styrene-acrylic resin | 100 parts by weight |
| Magnetic powder | 80 parts by weight |
| Charge control resin | see Tables 1 and 2 |

Image Density and Fog Density

Each type of magnetic one-component toner prepared as described above was loaded in a modified version of a model LS-9000 printer manufactured by Kyocera Corp., Japan, and the image density (ID) and the fog density (FD) in initial printing and after 100,000-sheet bulk printing were measured. Moreover, the initial image density under H/H environment conditions (temperature 35° C., humidity 85%) was also measured. The image density and the fog density were measured by measuring the density of a solid black portion of the printed image and the density of an unprinted portion thereof by using a reflection density meter (model TC-6D manufactured by Tokyo Denshoku Co., Ltd., Japan). The criteria for evaluation were as follows.

Evaluation Criteria for ID

An image density equal to or higher than 1.3 was evaluated as “GOOD,” an image density lower than 1.3 and equal to or higher than 1.2 as “FAIR,” and an image density lower than 1.2 as “POOR.”

Evaluation Criteria for FD

A fog density lower than 0.007 was evaluated as “GOOD,” a fog density equal to or higher than 0.007 and lower than 0.01 as “FAIR,” and a fog density equal to or higher than 0.01 as “POOR.”

Fixability

After fixing, a solid image was rubbed with a 1 kg weight wrapped in cloth that was moved ten times along a reciprocating path across the image. The ID was measured before and after the rubbing, and the fixing rate was calculated according to the following formula:

Fixing Rate (%)=(ID After Rubbing)/(ID Before Rubbing)×100

A fixing rate equal to or higher than 97% was evaluated as “GOOD,” a fixing rate equal to or higher than 95% and lower than 97% was evaluated as “FAIR,” and a fixing rate lower than 95% was evaluated as “POOR.”

With the magnetic one-component toners of Practical Examples 1 to 7 according to the present invention, the ID and FD were good both in initial printing and after bulk printing. Moreover, with these toners, the initial ID under H/H environment conditions was also good, and satisfactory fixability was obtained. By contrast, with the magnetic one-component toner of Comparative Example 1, of which the functional group content was as high as 18.0% by weight, the initial ID and FD were both poor. Thus, with this toner, the testing was finished here, without proceeding to bulk printing. With the magnetic one-component toner of Comparative Example 2, of which the functional group content was as low as 6.0% by weight, the initial ID was poor. Thus, with this toner, as with the toner of Comparative Example 1, the testing was finished here, without proceeding to bulk printing. With the magnetic one-component toner of Comparative Example 3, of which the weight-average molecular weight of the charge control resin was as high as 18,000, the ID after bulk printing was low, and the ID under H/H environment conditions was also low. This toner also exhibited poor fixability. With the magnetic one-component toner of Comparative Example 4, to which the charge control resin was added in as little as 3 parts by weight, the ID and FD after bulk printing were poor. Moreover, the initial ID under H/H environment conditions was also poor. With the magnetic one-component toner of Comparative Example 5, to which the charge control resin was added in as much as 25 parts by weight, and that of Comparative Example 6, of which the functional group content was as low as 7.0% by weight, the ID after bulk printing was poor. With the magnetic one-component toner of Comparative Example 7, of which the weight-average molecular weight of the charge control resin was as high as 16,000 and to which the charge control resin was added in as much as 25 parts by weight, the ID after bulk printing and the fixability were poor.

TABLE 1

| | | Practical | Practical | Practical | Practical | Practical | Practical | Practical |
|---|---|---|---|---|---|---|---|---|
| | | Example 1 | Example 2 | Example 3 | Example 4 | Example 5 | Example 6 | Example 7 |
| Charge Control | Weight-Average | 10,000 | 8,000 | 15,000 | 10,000 | 10,000 | 10,000 | 10,000 |
| Resin | Molecular Weight | | | | | | | |
| | Functional Group | 9.5 | 9.5 | 9.5 | 8.0 | 15.0 | 9.5 | 9.5 |
| | Content (wt %) | | | | | | | |
| | Parts by Weight Added | 9 | 9 | 9 | 9 | 9 | 5 | 20 |
| Initial Printing | ID | GOOD | GOOD | GOOD | FAIR | GOOD | GOOD | GOOD |
| | FD | GOOD | GOOD | GOOD | GOOD | FAIR | GOOD | GOOD |
| After Bulk | ID | GOOD | GOOD | GOOD | FAIR | GOOD | FAIR | FAIR |
| Printing | FD | GOOD | GOOD | GOOD | GOOD | FAIR | FAIR | GOOD |
| Initial Printing | ID | GOOD | GOOD | FAIR | GOOD | GOOD | GOOD | GOOD |
| (Under H/H Env.) | | | | | | | | |
| Fixability | | GOOD | GOOD | FAIR | GOOD | GOOD | GOOD | GOOD |

TABLE 2

| | | Comparative | Comparative | Comparative | Comparative | Comparative | Comparative | Comparative |
|---|---|---|---|---|---|---|---|---|
| | | Example 1 | Example 2 | Example 3 | Example 4 | Example 5 | Example 6 | Example 7 |
| Charge Control | Weight-Average | 10,000 | 10,000 | 18,000 | 10,000 | 10,000 | 10,000 | 16,000 |
| Resin | Molecular Weight | | | | | | | |
| | Functional Group | 18.0 | 6.0 | 9.5 | 9.5 | 9.5 | 7.0 | 9.5 |
| | Content (wt %) | | | | | | | |
| | Parts by Weight Added | 9 | 9 | 9 | 3 | 25 | 25 | 25 |
| Initial Printing | ID | POOR | POOR | GOOD | GOOD | GOOD | GOOD | GOOD |
| | FD | POOR | GOOD | GOOD | GOOD | GOOD | GOOD | GOOD |
| After Bulk | ID | — | — | POOR | POOR | POOR | POOR | POOR |
| Printing | FD | — | — | GOOD | POOR | GOOD | GOOD | GOOD |
| Initial Printing | ID | — | — | POOR | POOR | GOOD | GOOD | GOOD |
| (Under H/H Env.) | | | | | | | | |
| Fixability | | — | — | POOR | GOOD | GOOD | GOOD | POOR |

What is claimed is:

1. A magnetic one-component toner comprising at least a binder resin, a charge control resin, and a magnetic powder, wherein the charge control resin has a weight-average molecular weight of 1.5×10⁴ or less, contains 8 to 15% by weight of functional groups, and is added in 5 to 20 parts by weight to 100 parts by weight of the binder resin.

2. A magnetic one-component toner as claimed in claim 1, wherein the charge control resin has a weight-average molecular weight of 0.8×10⁴ or more.

3. A magnetic one-component toner as claimed in claim 1, wherein the magnetic powder is added in 60 to 90 parts by weight to 100 parts by weight of the binder resin.
